(19) United States
(12) Patent Application Publication
(10) Pub. No.: US 2025/0298577 A1
(43) Pub. Date: Sep. 25, 2025

(54) AUDIO APPARATUS AND AUDIO SYSTEM INCLUDING SAME

(71) Applicant: SAMSUNG ELECTRONICS CO., LTD., Suwon-si (KR)

(72) Inventors: Junpyo KIM, Suwon-si (KR); Jigwang KIM, Suwon-si (KR); Sungil BANG, Suwon-si (KR)

(73) Assignee: SAMSUNG ELECTRONICS CO., LTD., Suwon-si (KR)

(21) Appl. No.: 19/230,891

(22) Filed: Jun. 6, 2025

Related U.S. Application Data
(63) Continuation of application No. PCT/KR2023/018375, filed on Nov. 15, 2023.

(30) Foreign Application Priority Data
Jan. 3, 2023 (KR) 10-2023-0000938

(51) Int. Cl. G06F 3/16; A63F 13/22; G09G 3/34; G09G 3/36

(52) U.S. Cl. CPC G06F 3/165; A63F 13/22; G09G 3/3406; G09G 3/3696; G09G 2320/0233; G09G 2320/103; G09G 2354/00; G09G 2370/04

(57) ABSTRACT

An audio system includes an audio apparatus including a lighting module and a sound output portion; and a display apparatus including an input portion configured to communicate with the audio apparatus and transmit information about a type of input content displayable through the display apparatus that is identified based on data of the input content or a screen mode input by a user through the input portion. The audio apparatus is configured to control the lighting module and the sound output portion based on at least one of the information about the type of the input content received from the display apparatus or the screen mode input by the user.

### CROSS-REFERENCE TO RELATED APPLICATION

This application is a continuation application is a continuation application, under 35 U.S.C. § 111 (a), of international application No. PCT/KR2023/018375, filed Nov. 15, 2023, which claims priority under 35 U. S. C. § 119 to Korean Patent Application No. 10-2023-0000938, filed Jan. 3, 2023, the disclosures of which are incorporated herein by reference in their entireties.

### TECHNICAL FIELD

The disclosure relates to an audio apparatus and an audio system including the same.

### BACKGROUND ART

As technologies for various types of display apparatuses have been developed and commercialized, various types of content such as content on demand and movies may be provided through an external device such as a personal computer (PC), external server or game console, in addition to the broadcast received in real time. A home entertainment system that allows enjoyment of games and television (TV) on a single device has also become widely used. The home entertainment system may be referred to as an audio system.

In general, an audio system includes a display apparatus and an audio apparatus, and external devices such as a video cassette recorder (VCR) or a game console may also be connected.

A display apparatus is a type of output device for displaying obtained or stored image information to the user, and is used in various fields such as homes or workplaces. For example, the display apparatuses include monitors connected to personal or server computers, portable computer devices, navigation terminal devices, general television devices, or smartphones.

An audio apparatus is a device that audibly outputs an audio signal received from the outside to a user. For example, the audio apparatuses include a multi-channel sound output device such as a 5.1 channel device or an audio receiver.

### DISCLOSURE

### Technical Problem

The disclosure provides an audio apparatus and an audio system that may control a display apparatus and an audio apparatus in conjunction with each other based on input content.

### Technical Solution

According to an embodiment of the disclosure, an audio system may include: an audio apparatus including a lighting module and a sound output portion; and a display apparatus, including an input portion, configured to communicate with the audio apparatus and transmit information about a type of input content displayable through the display apparatus that is identified based on data of the input content or a screen mode input by a user through the input portion. The audio apparatus may be configured to control the lighting module and the sound output portion based on at least one of the information about the type of the input content from the display apparatus or the screen mode input by the user.

The display apparatus may be configured to determine the input content as a game genre based on the type of the input content being a game, and transmit information about the game genre of the input content to the audio apparatus, and the audio apparatus may be configured to control the lighting module and the sound output portion based on the game genre of the input content received from the display apparatus.

The display apparatus may be configured to determine a gaming feature and transmit information about the gaming feature to the audio apparatus, and the audio apparatus may be configured to control the lighting module and the sound output portion based on the information about the gaming feature received from the display apparatus.

The audio apparatus may be configured to determine whether the gaming feature is changed, and based on the gaming feature being changed, control a color and a brightness displayed by the lighting module based on the changed gaming feature.

The audio apparatus may be configured to control the lighting module based on a color and a brightness of a most changed gaming feature, based on a plurality of gaming features being changed.

The display apparatus may be configured to transmit index information of the data of the input content to the audio apparatus, and the audio apparatus may be configured to control the lighting module and the sound output portion based on the index information.

The display apparatus may further include at least one lighting device.

The display apparatus may be configured to determine a color and a brightness output to the at least one lighting device based on the data of the input content, and transmit the determined color and brightness to the audio apparatus, and the audio apparatus may be configured to control the lighting module based on the determined color and brightness.

The display apparatus may be configured to determine a color and a brightness output to the at least one lighting device based on information about a gaming feature, and transmit the determined color and brightness to the audio apparatus, and the audio apparatus may be configured to control the lighting module based on the determined color and brightness.

According to an embodiment of the disclosure, an audio apparatus may include: a sound output portion configured to output sound; a lighting module including a plurality of light emitting elements arranged in two dimensions; and a controller configured to control the lighting module and the sound output portion based on at least one of information about a type of input content received from a display apparatus or a screen mode of the display apparatus.

The controller may be configured to control the lighting module and the sound output portion based on a game genre of the input content received from the display apparatus.

The controller may be configured to control the lighting module and the sound output portion based on information about a gaming feature received from the display apparatus.

The controller may be configured to determine whether the gaming feature is changed, and based on the gaming feature being changed, control a color and a brightness displayed by the lighting module based on the changed gaming feature.

The controller may be configured to control the lighting module based on a color and a brightness of a most changed gaming feature, in response to a plurality of gaming features being changed.

The controller may be configured to control the lighting module and the sound output portion based on index information received from the display apparatus.

The controller may be configured to control the lighting module based on a determined color and brightness received from the display apparatus.

The determined color and brightness may be determined based on information about the gaming feature.

### Advantageous Effects

According to an aspect of the disclosure, an audio apparatus and an audio system may control a display apparatus and an audio apparatus in conjunction with each other based on input content.

### DESCRIPTION OF DRAWINGS

FIG. 1 is a view illustrating an audio system according to an embodiment.

FIG. 2 is a front view illustrating an example of an appearance of a display apparatus according to an embodiment.

FIG. 3 is a rear view illustrating an example of an appearance of a display apparatus according to an embodiment.

FIG. 4 is an exploded perspective view illustrating an example of a display apparatus according to an embodiment.

FIG. 5 is a control block diagram of a display apparatus according to an embodiment.

FIG. 6 and FIG. 7 are diagrams illustrating examples of determining a gaming feature of an input image according to an embodiment.

FIG. 8 is a front view illustrating an example of an appearance of an audio apparatus according to an embodiment.

FIG. 9 is a rear view illustrating an example of an appearance of an audio apparatus according to an embodiment.

FIG. 10 is a bottom view illustrating an example of an appearance of an audio apparatus according to an embodiment.

FIG. 11 is an exploded perspective view illustrating an example of an audio apparatus according to an embodiment.

FIG. 12 is a control block diagram of an audio apparatus according to an embodiment.

### MODES OF THE INVENTION

Various embodiments and the terms used therein are not intended to limit the technology disclosed herein to specific forms, and the disclosure should be understood to include various modifications, equivalents, and/or alternatives to the corresponding embodiments.

It will be understood that when an element is referred to as being “connected” to another element, it may be directly or indirectly connected to the other element, where indirect connection includes “connection via a wireless communication network.”

The terms used herein is for the purpose of describing particular embodiments only and is not intended to limit the disclosure. A singular form of a noun corresponding to an item may include one or more of the items unless clearly indicated otherwise in a related context. It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

Although the terms “first”, “second”, etc. may be used to describe various components, the terms do not limit the corresponding components, but are used only for the purpose of distinguishing one component from another. For example, without departing from the technical spirit or essential features of the disclosure, a first element may be referred to as a second element, and a second element may be referred to as a first element.

Furthermore, the terms, such as “˜ part”, “˜ block”, “˜ member”, “˜ module”, etc., may refer to a unit of handling at least one function or operation. For example, the terms may refer to at least one process handled by hardware such as a field-programmable gate array (FPGA)/application specific integrated circuit (ASIC), etc., software stored in a memory, or at least one processor.

The reference numerals used for method steps are for convenience of explanation, but not to limit an order of the steps. Thus, unless the context clearly dictates otherwise, the written order may be practiced otherwise.

Hereinafter, an operating principle and embodiments of the disclosure will now be described with reference to accompanying drawings.

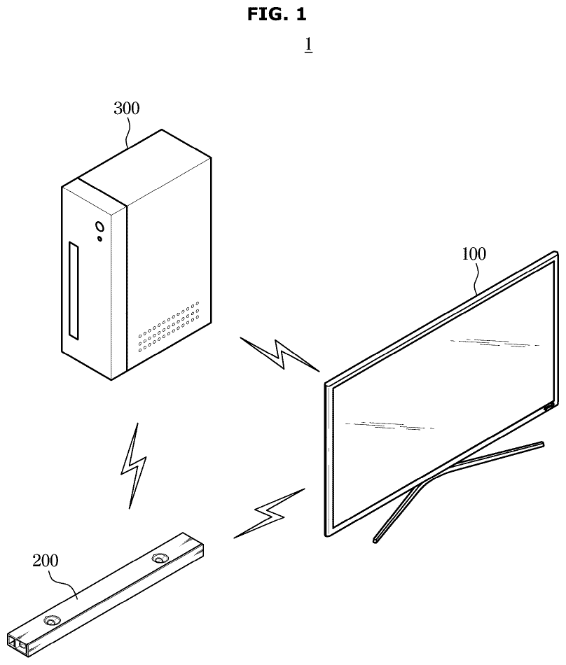

FIG. 1 is a view illustrating an audio system according to an embodiment.

Referring to FIG. 1, an audio system 1 includes a display apparatus 100, an audio apparatus 200, and an external device 300.

The display apparatus 100 may process an image signal received from the outside and may visually display the processed image. For example, the display apparatus may be a device that processes an image and visually displays the processed image, such as a mobile electronic device such as a television (TV), a personal digital assistant (PDA), a smartphone, a laptop computer, or a computer.

The display apparatus 100 according to an embodiment may receive content data wirelessly or wired from an external device and may display the received image. Here, content data is defined as a term including video data and audio data. The display apparatus 100 may process the received content data and transmit the processed content data to the audio apparatus 200. The display apparatus 100 may be equipped with a wired/wireless communication module to communicate with the audio apparatus and the external device.

The audio apparatus 200 may receive content data processing information from the display apparatus 100. In addition, the audio apparatus may control the output of the audio apparatus based on the received information. The audio apparatus 200 may be equipped with a wired/wireless communication module to communicate with the display apparatus and the external device.

The external device 300 refers to an image content providing device that outputs an image signal. The image content providing device may play image content stored by itself, or receive image content from an external image server.

For example, the external device may be implemented in various forms, such as an optical media player such as a digital video disc (DVD) or Blu-ray, a ultra-high definition (UHD) player, a set-top box, a TV, a main computer, a mobile device, a game console, and a home theater.

In addition, the external device 300 may also transmit compressed video in real time via wireless communication. In a wireless transmission environment, video data may be compressed according to a specific compression standard to transmit the video data, and may be transmitted to the display apparatus in the form of a bitstream. Video transmission in the form of a bitstream is referred to as streaming. The external device may be equipped with a wired/wireless communication module to communicate with the display apparatus, the audio apparatus, and an external server.

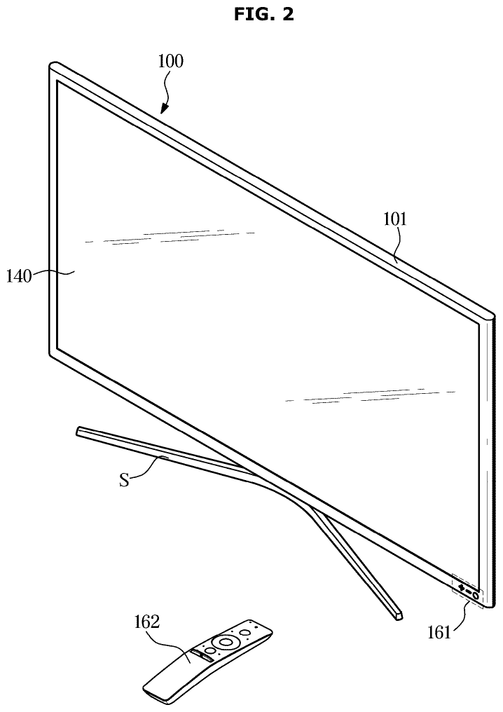

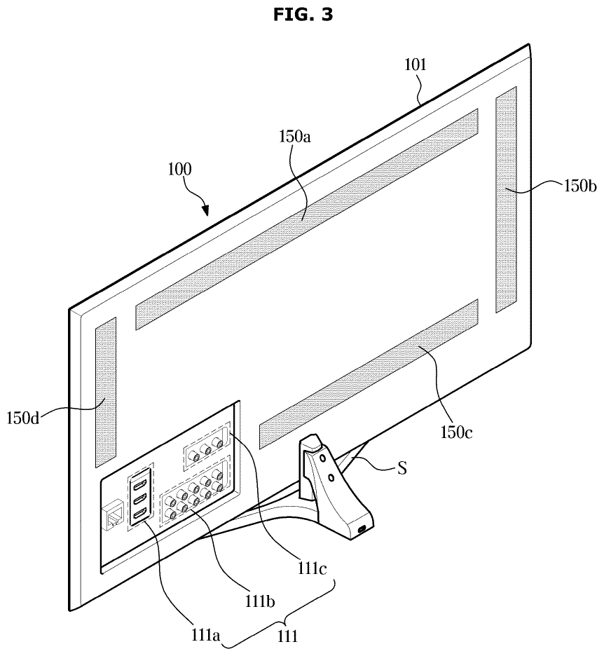

FIG. 2 is a front view illustrating an example of an appearance of a display apparatus according to an embodiment. FIG. 3 is a rear view illustrating an example of an appearance of a display apparatus according to an embodiment.

Referring to the example of FIG. 2, the display apparatus 100 may include a main body 101 that defines an appearance and accommodates or supports various components of the display apparatus 100.

A display portion 140 that displays an image may be arranged on the front of the main body 101, and a main body input portion 161 for receiving a control command from a user may be formed on at least one region of the front side of the main body 101. It is shown in FIG. 2 that the main body input portion 161 is formed on the front side of the main body 101 as an example, but the main body input portion 161 may be formed on the lower or rear portion of the main body 101. In the embodiment, the direction in which an image is displayed is defined as the front, and the opposite direction is defined as the rear.

The display portion 140 may use one of various display panels, such as a liquid crystal display (LCD) panel, a light emitting diode (LED) panel, an organic light emitting diode (OLED) panel, a field emission display (FED) panel, or a quantum dot light emitting diode (Q-LED) panel.

The main body input portion 161 may be implemented in the form of a button, a touch pad, or a dial or jog shuttle that the user pushes or turns.

In addition, the display apparatus 100 may further include a remote input portion 162 such as a remote control for allowing a user to input control commands even at a distance from the main body 101, in addition to the main body input portion 161 provided on the main body 101.

Examples of control commands input from the user include power on/off, sound level adjustment, broadcast channel selection, mode selection such as game mode/broadcast mode, and display characteristic adjustment such as screen brightness, contrast, and saturation.

The display apparatus 100 may process an image based on the control command input from the user. For example, in a case where a game mode is input from the user, an image processing time may be shortened compared to when it is not a game mode, thereby shortening an image response time to the user's operation.

Meanwhile, it is shown in FIG. 2 that the main body 101 is supported by a stand S and placed on a horizontal plane as an example. However, the above is only an example of the display apparatus 100, and a wall-mounted form in which a bracket is connected to the rear of the main body 101 and the bracket is installed on a wall may be implemented.

As described above, the display apparatus 100 may receive content data from the external device. For example, in a case where the display apparatus 100 is connected to the external device by wire and receive image content, a cable connector connecting the audio apparatus 200 and/or the external device 300 to the display apparatus 100 may be inserted into various types of cable ports 111 provided on the rear of the display apparatus 100 as shown in FIG. 3.

According to the example of FIG. 3, the cable port 111 may include a high-definition multimedia interface (HDMI) port 111a, a composite port 111b, and a component port 111c. An HDMI cable that transmits both video data and audio data may be connected to the HDMI port 111a, a single image signal cable and two audio signal cables may be connected to the composite port 111b, and three image signal cables and two audio signal cables may be connected to the component port 111c.

A user may connect the external device and the display apparatus 100 using an appropriate cable according to the standard supported by the external device. However, the cable port 111 of FIG. 3 is only an example that may be applied to the display apparatus 100, and some of the HDMI port 111a, the composite port 111b, and the component port 111c may be omitted. In a case where the standard is changed, a completely different type of port may be provided according to the changed standard.

In addition, the display apparatus 100 may be equipped with at least one lighting device 150 on the rear side of the display apparatus 100. The display apparatus 100 may control the lighting device 150 based on content data or user input.

As shown in FIG. 3, a plurality of lighting devices 150a, 150b, 150c, and 150d, which are the lighting device 150, may be installed along edges on the back of the display apparatus 100. The arrangement of the lighting devices is not limited to the above example, and any arrangement may be used as long as the arrangement is for providing an optimal viewing environment for the user. For example, the lighting device may be installed in a circular shape.

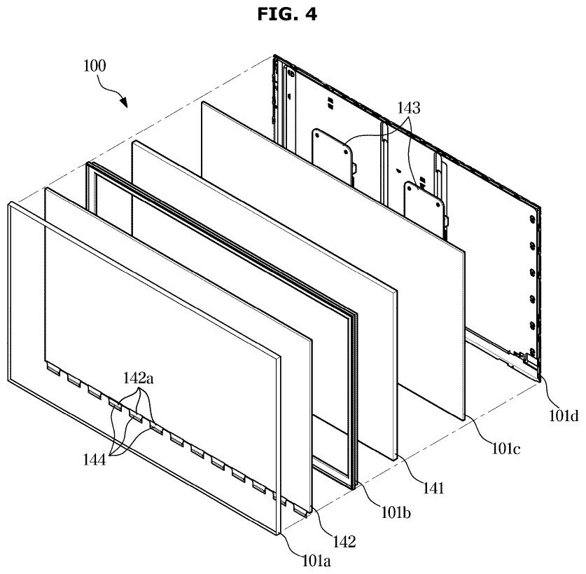

FIG. 4 is an exploded perspective view illustrating an example of a display apparatus according to an embodiment.

As shown in FIG. 4, various components for generating images may be provided inside the main body 101.

For example, the main body 101 may be provided with a backlight unit 141 that emits surface light forward, a liquid crystal panel 142 that blocks or transmits light emitted from the backlight unit 141, and a power/control unit 143 that controls the operation of the backlight unit 141 and the liquid crystal panel 142.

In addition, the main body 101 may further be provided with a bezel 101a, a frame middle mold 101b, a bottom chassis 101c, and a rear cover 101d for supporting and fixing the liquid crystal panel 142, the backlight unit 141, and the power/control unit 143.

The backlight unit 141 may include a point light source that emits monochromatic light or white light, and may refract, reflect, and scatter light to convert light emitted from the point light source into uniform surface light. For example, the backlight unit 141 may include a light source that emits monochromatic light or white light, a light guide panel that receives light from the light source and scatters the incident light, a reflective sheet that reflects light emitted from the rear surface of the light guide panel, and an optical sheet that refracts and scatters light emitted from the front surface of the light guide panel.

The liquid crystal panel 142 is provided in front of the backlight unit 141, and may form an image by blocking or transmitting light emitted from the backlight unit 141.

The liquid crystal panel 142 may include a plurality of pixels arranged in a two-dimensional matrix form. The plurality of pixels P included in the liquid crystal panel 142 may independently block or transmit light from the backlight unit 141, and light emitted from the plurality of pixels P may form an image displayed on the display apparatus 100.

The power/control unit 143 may include a power circuit that supplies power to the backlight unit 141 and the liquid crystal panel 142, and a control circuit that controls the operation of the backlight unit 141 and the liquid crystal panel 142.

The power circuit may supply power to the backlight unit 141 to allow the backlight unit 141 to emit surface light, and may supply power to the liquid crystal panel 142 to allow the liquid crystal panel 142 to transmit or block light.

The control circuit may adjust a voltage applied to each of the plurality of pixels constituting the liquid crystal panel 142. In addition, control circuit may adjust an intensity of light emitted by the backlight unit 141.

The power/control unit 143 may be implemented as a printed circuit board and various circuits mounted on the printed circuit board. For example, the power circuit may include a condenser, a coil, a resistance element, a microprocessor, etc., and a power circuit board on which the above elements are mounted. In addition, the control circuit may include a memory, a microprocessor, and a control circuit board on which the above elements are mounted.

Between the liquid crystal panel 142 and the power/control unit 143, a cable 142a for transmitting image data from the power/control unit 143 to the liquid crystal panel 142 and a display driver integrated circuit (DDI) 144 (hereinafter referred to as a “display drive unit”) for processing the image data may be provided.

The cable 142a may electrically connect the power/control unit 143 and the display drive unit 144, and electrically connect the display drive unit 144 and the liquid crystal panel 142.

The display drive unit 144 may receive image data from the power/control unit 143 through the cable 142a, and may transmit the image data to the liquid crystal panel 142 through the cable 142a.

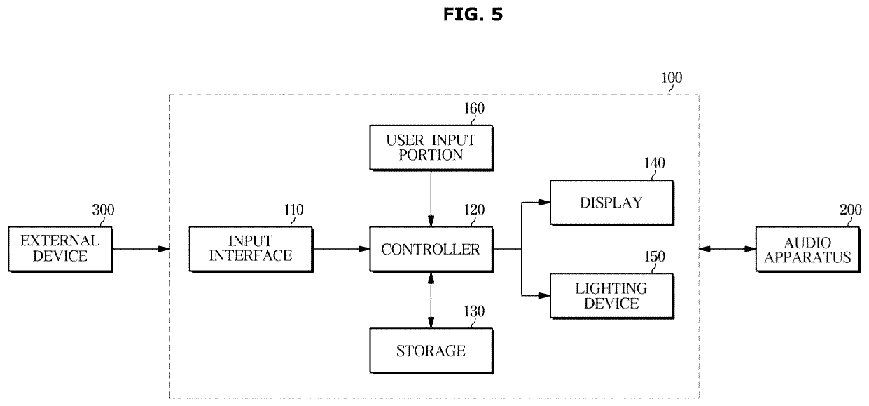

FIG. 5 is a control block diagram of a display apparatus according to an embodiment.

Referring to FIG. 5, the display apparatus 100 according to an embodiment includes an input interface 110, a controller 120, a storage 130, the display portion 140, the lighting device 150, and a user input portion 160. All components are electrically connected and may communicate with each other.

The input interface 110 may include the cable port 111 for connection with the audio apparatus 200 and/or the external device 300, and as described above, the cable port 111 may include at least one type of port according to a transmission standard of video data/audio data.

A user may connect the external device 300 and the display apparatus 100 using a cable that conforms to a standard applied to the external device 300 that provides content data. In addition, the input interface 110 may include a universal serial bus (USB) terminal.

The input interface 110 may include a decoder that decodes compressed video. For example, in a case where the display apparatus 100 receives a compressed video in the form of a bitstream, the decoder may decompress the image by performing decoding opposite to the compression process of the image.

As described above, content data may include video data and audio data. In the embodiment described below, video data included in the input content data is referred to as input image. The input interface 110 may transmit the content data to the controller 120.

The controller 120 may determine characteristics of the input image based on the content data, and control the display portion 140 and the lighting device 150 based on the determined characteristics of the input image.

For example, the controller 120 may process the image, displayed on the display portion 140, based on the type of the input image, game genre, and/or gaming feature, and the controller 120 may determine a color and a brightness output from the lighting device 150 based on the type of the image, genre, and/or gaming feature.

To this end, the controller 120 may determine the characteristics of the input image including the type of input content, the game genre, and/or the gaming feature.

Specifically, the controller 120 may determine the type of input content. For example, the type of the content may include game content and general video content. Here, the general video content refers to video content other than games.

By connecting the external device 300 (e.g., an external server) to the display apparatus 100, a game flag may be transmitted from the external device. The game flag may include a value to distinguish between a game mode and a video mode. For example, in a case where the value of the transmitted game flag is 1, it may be defined as a game mode, and in a case where the value of the transmitted game flag is 0, it may be defined as a video mode. Accordingly, in a case where the game flag transmitted from the external device 300 is 1, the controller 120 may determine the content of the input image as a game, and in a case where the game flag transmitted is 0, the controller 120 may determine the content of the input image as a general video.

The type of general video content may include at least one of sports broadcast, movies, and general broadcast. Here, the general broadcast may refer to video content other than sports broadcast and movies among general video content.

In a case where the content of the input image is a general video, the controller 120 may determine whether the content of the input image is a movie or a sports broadcast by using at least one characteristic of a color, depth, motion, or voice of the input image. For example, in a case where the color of the input image has a green or blue characteristic, the content of the input image may be determined as a sports broadcast of football, baseball, golf, and the like.

Meanwhile, in a case where the type of input content is a game, the controller 120 may determine a game genre of the input content. Hereinafter, an operation of determining a game genre is described in detail.

For example, the game genre may include at least one of first-person shooter (FPS), racing, roleplaying game (RPG), real-time strategy (RTS), or aeon of strife (AOS).

First-person shooter (FPS) is a type of shooting game in which a gameplay is presented from a player's perspective and involves combat with weapons or tools. Game images in the FPS genre may be produced mainly in three-dimension (3D) graphics from the player's perspective.

Racing is a type of game in which a player competes in a race and is presented from a player's perspective. Game images in the racing genre may also be produced mainly in 3D graphics from the player's perspective.

Roleplaying game (RPG) is a type of role-playing game in which players assume roles of characters in the game and develop a narrative.

Real-time strategy (RTS) is a type of strategy game that is played in real time, and aeon of strife (AOS) is a type of game that combines the characteristics of RTS and RPG.

The controller 120 may determine the game genre based on different characteristics of images provided for each game genre.

FPS game genre tends to exhibit a lot of frequent and rapid panning motion.

Racing game genre tends to involve minimal panning motion but features smooth movement of vanishing points. RPG game genre tends to include rapid transitions between images without maintaining a constant pattern, and RTS game genre tends to show minimal depth variation across the input images and frequent detection of panning motion. In addition, AOS game genre combines the image characteristics of RPG game genre and RTS game genre.

The controller 120 may determine the game genre of the input content considering the above features. Specifically, in a case where the genre-specific features of the input images satisfy a preset time or preset number of times, the controller 120 may determine a corresponding game genre as the game genre of the input image.

In addition, in a case where the type of input content is a game, the controller 120 may determine a gaming feature of the input content. The gaming feature refers to a feature that is displayed on the display so as to allow a user to play the game smoothly.

For example, for the FPS game genre, a remaining time until the end of the game, targets, and weapons may be gaming features. For the racing game genre, an engine RPM gauge, information about a driving environment, and the like may be gaming features. For the RPG game genre, map information, character stamina information, and the like may be gaming features. For the RTS game genre, map information, information about a user's race, and the like may be gaming features. For the AOS game genre, map information, character stamina information, character skill information, and the like may be gaming features.

However, gaming features are not limited to the examples described above, and any gaming features may be used as long as the gaming features are displayed to assist the user in playing the game. For example, gaming features may be game information, such as character information set by the user, and may also be information that temporarily appears and disappears from the display depending on the game play.

The controller 120 may determine the gaming feature based on the input image. For example, the controller 120 may determine changes in a plurality of consecutively input frame images as the gaming feature.

The above is merely an example of determining the gaming feature of the input image by the controller 120, and the gaming feature of the input image may be determined in a different manner in addition to the above-described example. For example, the controller 120 may also determine the gaming feature based on metadata of the input image.

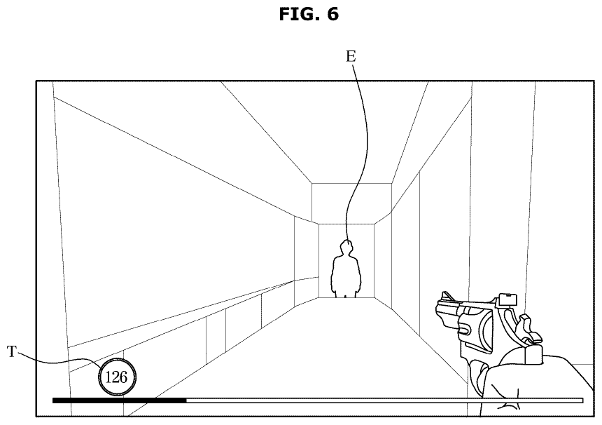

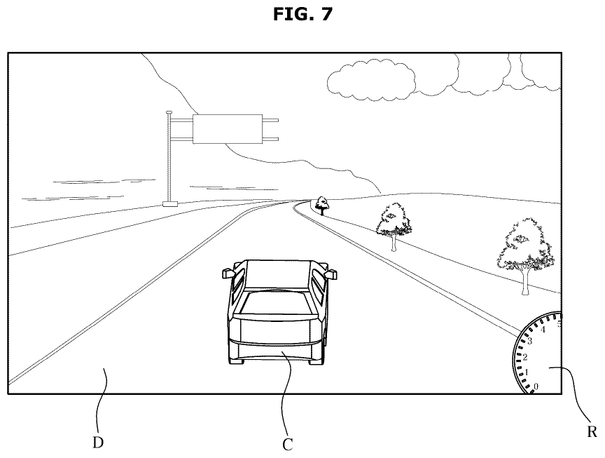

FIG. 6 and FIG. 7 are diagrams illustrating examples of determining a gaming feature of an input image.

Referring to FIG. 6, the controller 120 may determine remaining time information T, enemy information E, and the like, as gaming features, using a plurality of consecutively input frame images.

In addition, referring to FIG. 7, based on metadata of input images, the controller 120 may determine vehicle information C, engine RPM information R, and driving environment information D, and the like, as gaming features. The vehicle information may include a ranking of a driving vehicle, a color of the vehicle, and the like.

In addition, the controller 120 may determine index information of the input image. The index information may correspond to index information for a corresponding scene, such as information about a time such as dawn, day, or night, or information about a place such as the sky, the sea, or a mountain.

Specifically, the controller 120 may determine the index information based on metadata of the input image.

The controller 120 may transmit a user control command, a determined type of input content, a game genre, a gaming feature, characteristics of the input image including index information, and audio data, to the audio apparatus 200 through the user interface 110 or the communication module.

The controller 120 may perform image processing on video data based on the user's control command or the determined input image characteristics. Specifically, the controller 120 may determine parameters related to image processing based on the user's control command or the input image characteristics, and perform image processing on the video data according to the parameters.

For example, in a case where the type of input content is sports broadcast, movies, or general broadcast in which the user passively watches a video, the controller 120 may increase the number of reference frames to process the video data, thereby implementing a high-quality image. In a case where the type of input content is game content, the controller 120 may shorten an image processing time compared to general video content, thereby shortening an image response time to a user's operation. In a case where a game mode is input by the user, the controller 120 may shorten an image processing time compared to general video content.

According to an embodiment, the controller 120 may determine an image processing parameter according to the user input, in a case where the determined type of input content is different from a screen mode input from the user.

In addition, in a case where the type of input content is game content, the image processing parameters may be set differently depending on the game genre. For example, in a case where the game genre is FPS, the parameter with the shortest image processing time may be set, and in a case where the game genre is RPG, the parameter with the longest image processing time may be set.

In addition, the controller 120 may control a color and a brightness output from the lighting device 150 based on the determined characteristics of the input image.

For example, in a case where the type of input content is a sports broadcast, the controller 120 may control the color output of the lighting device 150 to green, and in a case where the type of input content is a movie, the controller 120 may control the brightness of the lighting device 150 to 0.

In addition, in a case where the type of input content is game content, the color and brightness output from the lighting device 150 may be controlled differently depending on the game genre and gaming feature. For example, in a case where the game genre is racing, the color output from the lighting device 150 may be determined differently depending on a starting signal count, and the color of the lighting device 150 may be controlled to be the same color as the color of the RPM gauge.

The controller 120 may transmit the color and the brightness of the lighting device 150 to the audio apparatus 200 through the input interface 110 or the communication module.

The storage 130 may temporarily or non-temporarily store video data and audio data included in the input content data. The storage 130 may temporarily or non-temporarily store data required for image processing of the input image.

The storage 130 may store data about the type of content determined by the controller 120, the genre of the content, the gaming feature, and the index information of the input content data, and may store data about image processing parameters and a lighting device control method, and the like.

The storage 130 may include at least one of volatile memory or non-volatile memory. In addition, the storage 130 is not necessarily required to be physically separated from the controller 120, and the storage 130 and the controller 120 may be integrated on a single chip or share a memory.

The display portion 140 may display video data on which image processing has been performed by the controller 120 as an image. The configuration of the display portion 140 is the same as described above.

The lighting device 150 may output the color and brightness determined by the controller 120. The lighting device 150 may include a plurality of light emitting elements, a printed circuit board on which the plurality of light emitting elements are arranged, and a diffuser plate.

For example, the light emitting elements may be provided as light emitting diodes (LEDs) or organic light emitting diodes (OLEDs). The light emitting diodes may be implemented in various sizes and may include, for example, mini LEDs and/or micro LEDs.

The input portion 160 may include the aforementioned main body input portion 161 and remote input portion 162 to receive user input.

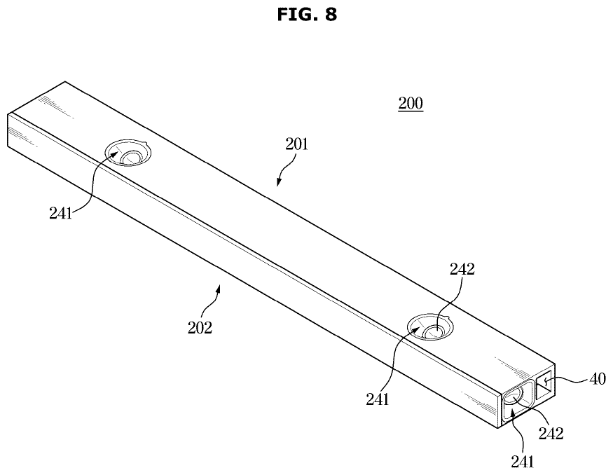

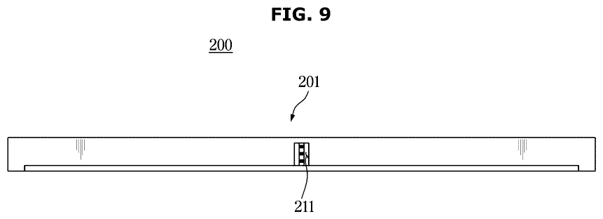

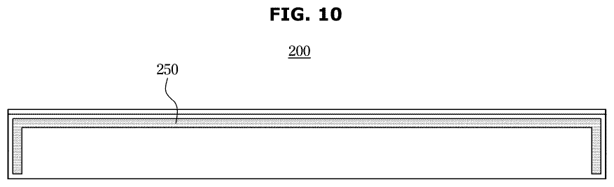

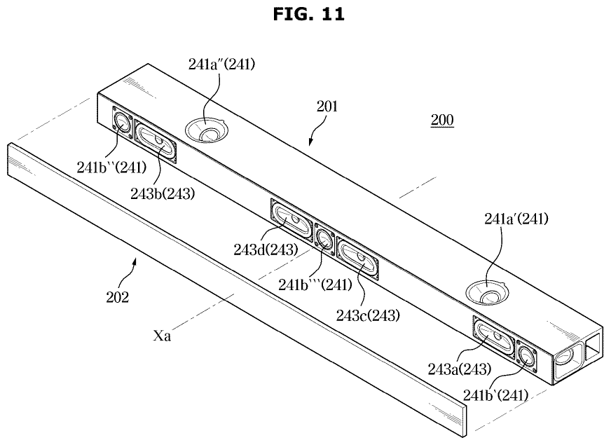

FIG. 8 is a front view illustrating an example of an appearance of an audio apparatus according to an embodiment. FIG. 9 is a rear view illustrating an example of an appearance of an audio apparatus according to an embodiment. FIG. 10 is a bottom view illustrating an example of an appearance of an audio apparatus according to an embodiment. FIG. 11 is an exploded perspective view illustrating an example of an audio apparatus according to an embodiment.

Referring to FIG. 8 to FIG. 11, the audio apparatus 200 may include a speaker 241, a main body 201 on which the speaker 241 is mounted, and a cover 202 provided at the front of the main body 201. The audio apparatus 200 may be formed in a bar shape.

The speaker 241 is a device that converts an electrical signal into vibration of a vibration plate 242 to generate sound. The speaker 241 may include a magnetic circuit portion (not shown) and a vibration system (not shown).

The magnetic circuit portion may be a portion through which an electrical signal is transmitted to the speaker 241 to generate sound. The magnetic circuit portion includes a magnet and a pole piece arranged in the center of the magnet.

In the vibration system, sound is generated and output as vibration, and may include a voice coil provided in a gap formed between a magnet and a pole piece, a bobbin on which the voice coil is installed, and the vibration plate 242 that is provided to be movable by the magnetic circuit in which the magnetic circuit portion is formed.

According to the above structure, the speaker 241 may convert an electrical signal into the vibration of the vibration plate 242, and may generate a wave of condensation and rarefaction in the air through the vibration, thereby generating sound.

A plurality of speakers 241 may be provided and arranged symmetrically with each other. More specifically, the speakers 241 may be arranged symmetrically with each other based on the center axis Xa of the main body 201.

The main body 201 may have a bar shape that extends in a first direction (e.g., Y direction). The main body 201 may be provided as an approximately rectangular parallelepiped shape with the first direction (e.g., Y direction) being the longitudinal direction.

The main body 201 may include an outer wall forming the exterior and an inner wall provided inside the main body 201. The outer wall may include a front wall facing the cover 202 and a rear wall parallel to the front wall and facing the rear.

The outer wall may further include a right wall, a left wall, a bottom wall, and an upper wall provided between the front wall and the rear wall.

A cable connector connecting the display apparatus 100 or the external device 300 to the audio apparatus 200 may be inserted into a connection port 211 provided on the rear of the audio apparatus 200. However, the audio apparatus 200 is not limited thereto, and may be wirelessly connected to other home appliances via a wireless communication method to transmit and receive signals.

The audio apparatus 200 may be provided with a lighting module 250 on a bottom side of the audio apparatus 200. The lighting module 250 may irradiate light to the bottom of the audio apparatus 200 by including an array of light emitting elements as described below.

The audio apparatus 200 may include a plurality of speakers 241. The speakers 241 may include a pair of upper speakers 241a mounted on the upper wall of the main body 201. The upper speakers 241a may be provided on each side of the upper wall with respect to the center axis Xa.

The upper speakers 241a may include a first upper speaker 241a′ mounted on the right side of the upper wall and a second upper speaker 241a″ mounted on the left side of the upper wall. The first upper speaker 241a′ and the second upper speaker 241a″ may be arranged to generate sounds toward the upper right and left sides of the audio apparatus 200, respectively.

The speaker 241 may include a plurality of front speakers 241b mounted on the front wall of the main body 201. Three front speakers 241b may be provided. The front speakers 241b may include a first front speaker 241b′ provided on the right side of the front wall, a second front speaker 241b″ provided on the left side of the front wall, and a third front speaker 241b provided on the center axis Xa.

The first front speaker 241b′ may generate sound toward the right side of the front (e.g., in the X direction) of the main body 201, and the second front speaker 241b″ may generate sound toward the left side of the front (e.g., in the −X direction) of the main body 201. The third front speaker 241b′″ is provided on the center axis Xa of the main body 201 and may generate sound in the forward direction (e.g., in the X direction). However, the shape, position, and number of the speakers 241 are not limited thereto.

A plurality of woofers 243 may be mounted on the front wall of the main body 201. A woofer may be a component to reproduce low-frequency sounds of 3,000 Hz or less in the audible frequency range. The plurality of woofers 243 may be mounted on the main body 201 to generate sounds in various frequency ranges and improve consumer satisfaction.

The plurality of woofers 243 may include a first woofer 243a provided on the right side of the center axis Xa of the main body 201 and a second woofer 243b provided on the left side of the center axis Xa of the main body 201. The first woofer 243a may be adjacent to the first front speaker 241b′. The second woofer 243b may be adjacent to the second front speaker 241b″.

The plurality of woofers 243 may include a third woofer 243c and a fourth woofer 243d provided as a pair adjacent to the third front speaker 241b′″. However, the position and number of woofers 243 are not limited thereto.

The cover 202 may be attached to the front side of the main body 201. The cover 202 may be coupled to the front wall to protect the plurality of woofers 243 and the front speaker 241 provided on the front wall of the main body 201. The cover 202 may be provided in the form of a grille. Accordingly, the cover 202 may prevent the front speaker 241 and the front woofer 243 from being pressed by a sharp element, and may also provide an aesthetic appeal.

However, the arrangement and shape of the cover 202 are not limited thereto, and the cover 202 may be provided to cover the upper wall, the right wall, and the left wall of the main body 201.

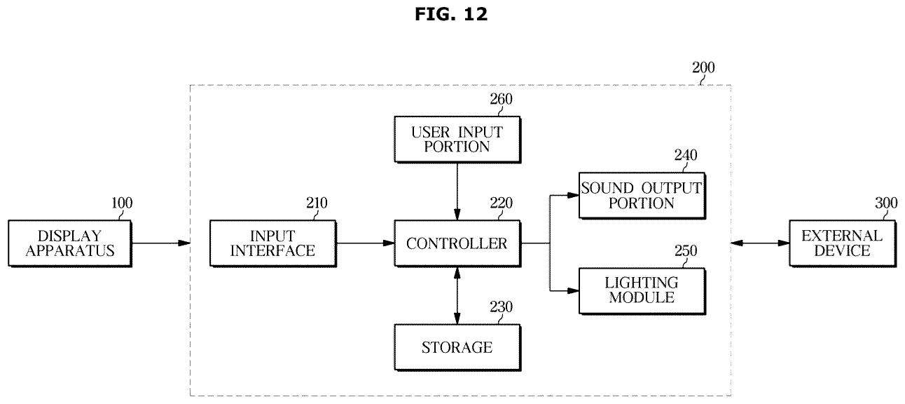

FIG. 12 is a control block diagram of an audio apparatus according to an embodiment.

Referring to FIG. 12, the audio apparatus 200 according to an embodiment includes an input interface 210, a controller 220, a storage 230, a sound output portion 240, the lighting module 250, and a user input portion 260. All components are electrically connected and may communicate with each other.

The input interface 210 may include the connection port 211 for connection with the display apparatus 100 and/or the external device 300, and the connection port 211 may include an HDMI port, a C-type port, a USB terminal, etc. A user may connect the display apparatus 100 and the audio apparatus 200 using a cable that conforms to a standard applied to the display apparatus 100.

The input interface 210 may output characteristics of an input image including the type of an image received from the display apparatus 100, a game genre, a gaming feature, or index information, a user control command, and audio data to the controller 220. In addition, the controller may receive various information through the communication module.

The controller 220 may control the sound output portion 240 and the lighting module 250 based on the information received from the display apparatus 100.

Specifically, the controller 220 may determine parameters related to sound processing based on the user control command or the characteristics of the input image, and may perform sound-processing on the audio data according to the parameters.

For example, in a case where the type of input content is dramas, movies, or general broadcast in which a user passively watches a video, the controller 220 may amplify the sound of voice and process the audio data to clearly transmit the voice. In a case where the type of input content is game content, the controller 220 may amplify a background sound compared to general video content to increase the liveliness of the game. In a case where a game mode is input by a user, the controller 220 may also amplify a background sound compared to general video content.

According to an embodiment, in a case where the determined input content type and a screen mode input by the user are different from each other, the controller 220 may determine sound processing parameters according to user input.

In addition, in a case where the type of input content is game content, sound processing parameters may be set differently depending on the game genre and gaming feature. For example, in a case where the game genre is FPS, the three-dimensionality of sound may be increased by performing spatial audio processing on the audio data, and in a case where the game genre is racing, the audio data may be processed by amplifying an output of the woofer to increase the liveliness of the racing.

In addition, the controller 220 may control a color and a brightness output from the lighting module 250 based on the characteristics of the input image.

For example, in a case where the type of input content is a sports broadcast, the controller 220 may control the color output from the lighting module 250 to green. The controller 220 may control the brightness of the lighting module 250 to 0 in a case where the type of input content is a movie. The controller 220 may control the color output from the lighting module 250 to green in a case where a sports mode is input by the user.

In addition, in a case where the type of input content is game content, the color and the brightness output from the lighting module 250 may be controlled differently depending on the game genre and gaming feature. For example, in a case where the game genre is FPS, the lighting module 250 may be controlled to allow only the light emitting element in the direction in which sound is output to emit light.

In addition, the controller 220 may determine whether the gaming feature has changed. For example, the controller 220 may process information about the gaming feature received from the display apparatus to determine whether the gaming feature has changed.

The controller 220 may control the color and the brightness output from the lighting module based on the changed gaming feature, in a case where the gaming feature has changed. For example, based on a change in color of an RPM gauge according to a user input in a racing game, the controller 220 may control the color of the lighting module 250 to be the same color as the color of the RPM gauge.

In a case where a plurality of gaming features have changed, the controller 220 may process information about the gaming features received from the display apparatus to determine the most changed gaming feature. For example, the controller 220 may determine the number of times the gaming feature has changed during a unit time (e.g., 5 seconds), and determine the gaming feature with the highest number of changes as the most changed gaming feature.

The controller 220 may control the lighting module based on the color and the brightness of the gaming feature that has changed the most. For example, in the FPS genre, when a user fires a gun in a rapid succession, the controller 220 may control the color of the lighting module 250 to be the same color as the color of the flame based on the flames generated by the shooting.

The controller 220 may control the color and the brightness of the lighting module 250 based on index information received from the display apparatus 100. Specifically, the controller 220 may control the color and the brightness of the lighting module 250 based on information of a current scene indicated by the index information.

For example, in a case where the index information received from the display apparatus 100 is the sky, the controller 220 may control the color of the lighting module 250 to sky blue and control the brightness to the maximum.

In addition, the controller 220 may control the color and the brightness of the lighting module 250 based on a color and a brightness of the lighting device 150 received from the display apparatus 100. For example, the controller 220 may control the color and the brightness of the lighting module 250 to be the same as the color and the brightness of the lighting device 150 received from the display apparatus 100, and may control the color of the lighting device 150 received from the display apparatus 100 and the color of the lighting module 250 to be emitted in a gradient.

The storage 230 may temporarily or non-temporarily store audio data. The storage 230 may temporarily or non-temporarily store data required for sound processing.

The storage 230 may store data about the type of content received from the display apparatus 100, genre of the content, gaming feature, and index information of input content data, and may store data about sound processing parameters and a lighting module control method.

The storage 230 may include at least one of volatile memory or non-volatile memory. In addition, the storage 230 is not necessarily required to be physically separated from the controller 220, and the storage 230 and the controller 220 may be integrated on a single chip or share a memory.

The sound output portion 240 may include the speaker 241, the vibration plate 242, and the woofer 243 described above, and the sound output portion 240 may output the audio data for which sound processing has been performed by the controller 220 as sound.

The lighting module 250 may output the color and the brightness determined by the controller 220. The lighting module 250 may include a plurality of light emitting elements, a printed circuit board on which the plurality of light emitting elements are arranged, and a diffusion plate.

For example, the light emitting elements may be provided as light emitting diodes (LEDs) or organic light emitting diodes (OLEDs). The light emitting diodes may be implemented in various sizes and may include, for example, mini LEDs and/or micro LEDs.

The input portion 260 may include an input button 261 and a signal receiving portion 262 to receive user input. The input button 261 may be implemented in the form of a button, a touch pad, or a dial or jog shuttle that the user pushes or turns.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that may be interpreted by a computer. For example, the computer-readable recording medium may be a read only memory (ROM), a random access memory (RAM), a magnetic tape, a magnetic disk, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

1. An audio system, comprising:
an audio apparatus including a lighting module and a sound output portion; and
a display apparatus, including an input portion, configured to communicate with the audio apparatus and transmit information about a type of input content displayable through the display apparatus that is identified based on data of the input content or a screen mode input by a user through the input portion,
wherein the audio apparatus is configured to control the lighting module and the sound output portion based on at least one of the information about the type of the input content from the display apparatus or the screen mode input by the user.

2. The audio system of claim 1, wherein the display apparatus is configured to determine the input content as a game genre based on the type of the input content being a game, and transmit information about the game genre of the input content to the audio apparatus, and
the audio apparatus is configured to control the lighting module and the sound output portion based on the game genre of the input content received from the display apparatus.

3. The audio system of claim 2, wherein the display apparatus is configured to determine a gaming feature and transmit information about the gaming feature to the audio apparatus, and
the audio apparatus is configured to control the lighting module and the sound output portion based on the information about the gaming feature received from the display apparatus.

4. The audio system of claim 3, wherein the audio apparatus is configured to determine whether the gaming feature is changed, and based on the gaming feature being changed, control a color and a brightness displayed by the lighting module based on the changed gaming feature.

5. The audio system of claim 4, wherein the audio apparatus is configured to control the lighting module based on a color and a brightness of a most changed gaming feature, based on a plurality of gaming features being changed.

6. The audio system of claim 1, wherein the display apparatus is configured to transmit index information of the data of the input content to the audio apparatus, and
the audio apparatus is configured to control the lighting module and the sound output portion based on the index information.

7. The audio system of claim 1, wherein the display apparatus further comprises:
at least one lighting device, and
the display apparatus is configured to determine a color and a brightness output to the at least one lighting device based on the data of the input content, and transmit the determined color and brightness to the audio apparatus, and
the audio apparatus is configured to control the lighting module based on the determined color and brightness.

8. The audio system of claim 7, wherein the display apparatus is configured to determine a color and a brightness output to the at least one lighting device based on information about a gaming feature, and transmit the determined color and brightness to the audio apparatus, and
the audio apparatus is configured to control the lighting module based on the determined color and brightness.

9. An audio apparatus, comprising:
a sound output portion configured to output sound;
a lighting module including a plurality of light emitting elements arranged in two dimensions; and
a controller configured to control the lighting module and the sound output portion based on at least one of information about a type of input content received from a display apparatus or a screen mode of the display apparatus.

10. The audio apparatus of claim 9, wherein the controller is configured to control the lighting module and the sound output portion based on a game genre of the input content received from the display apparatus.

11. The audio apparatus of claim 10, wherein the controller is configured to control the lighting module and the sound output portion based on information about a gaming feature received from the display apparatus.

12. The audio apparatus of claim 11, wherein the controller is configured to determine whether the gaming feature is changed, and based on the gaming feature being changed, control a color and a brightness displayed by the lighting module based on the changed gaming feature.

13. The audio apparatus of claim 12, wherein the controller is configured to control the lighting module based on a color and a brightness of a most changed gaming feature, based on a plurality of gaming features being changed.

14. The audio apparatus of claim 9, wherein the controller is configured to control the lighting module and the sound output portion based on index information received from the display apparatus.

15. The audio apparatus of claim 9, wherein the controller is configured to control the lighting module based on a determined color and brightness received from the display apparatus.
